(19) United States
(12) Patent Application Publication
(10) Pub. No.: US 2010/0065219 A1
(43) Pub. Date: Mar. 18, 2010

(54) ENCAPSULATION MOULD

(75) Inventor: Ciro Paudice, Vasto (IT)

Correspondence Address: BUCHANAN, INGERSOLL & ROONEY PC, POST OFFICE BOX 1404, ALEXANDRIA, VA, 22313-1404, US

(73) Assignee: Pilkington Italia S.p.A., San Salvo (IT)

(21) Appl. No.: 12/439,074

(22) PCT Filed: Aug. 31, 2008
(86) PCT No.: PCT/EP07/07624

§ 371 Date: Apr. 15, 2009

(30) Foreign Application Priority Data
Aug. 31, 2006 (EP) 06425605.0

(51) Int. Cl. B29C 39/10

(52) U.S. Cl. 156/500; 425/95

(57) ABSTRACT

An automotive glazing encapsulation mould is provided. The mould comprises at least a first half mould, having a moulding surface for moulding a gasket onto a glazing. The moulding surface comprises a layer of a silicone-free resilient polymer material supported on a rigid former. Preferably, the silicone-free resilient polymer material is polyurethane.

The present invention relates to moulds used in low pressure injection moulding processes, in particular, to moulds used in the encapsulation of automotive glazings.

In order to be fitted into a vehicle, an automotive glazing is provided with a gasket adhered to the periphery of the glazing. The gasket performs a four-fold function: firstly, it provides a spacer to ensure that the glazing is spaced a constant distance apart from the vehicle body at any point; secondly, it provides a bed onto which adhesive can be placed to secure the glazing into the vehicle body; thirdly, it provides a watertight seal between the glazing and the vehicle body; and fourthly, it conceals the adhesive from view and damage by sunlight. The gasket may be provided by extrusion, for example, using polyurethane or a thermoplastic polymer, by adhering a pre-formed part to the glass, or by injection moulding. The requirements of the automotive glazing market are such that gaskets and other preformed components are provided on the glazing by the glazing manufacturer, and sold to a vehicle manufacturer as a fully finished part.

Reaction injection moulding (RIM) has been used extensively within the automotive industry to mould gaskets onto automotive glazings. For example, EP 0 156 882 describes a RIM process for the manufacture of an automotive glazing and gasket assembly where polyurethane is injected into a metal mould clamped around the glazing. The main advantage of using the RIM method is the speed at which the mould is filled, coupled with the setting time of the polyurethane, so that a finished glazing is obtained in less than 90 seconds. In addition, other, preformed parts required that need to be adhered to the surface of the glazing, such as studs, spacers, or other metal or plastic parts can be placed into the mould before the polyurethane is injected. The general moulding process is commonly known as encapsulation.

Metal moulds are used to withstand the high pressures necessary to enable the injection of polyurethane. However, one major disadvantage is that metal moulds are very expensive. This is mainly due to the complex manufacturing process and the tight tolerances necessary to enable a glazing to be placed into the mould without breaking. In addition, it may be necessary to apply anti-sticking agents to the inner surfaces of the moulds to enable the finished glazing to be removed without damage to the gasket.

There is therefore a need for a mould, suitable for use in RIM moulding of automotive glazings, which has an increased lifetime compared with silicone moulds, and a decreased cost per part compared with parts made in metal moulds.

The present invention aims to address these problems by providing an automotive glazing encapsulation mould, comprising at least a first half mould, having a moulding surface for moulding a gasket onto a glazing, wherein the moulding surface comprises a layer of a silicone-free resilient polymer material supported on a rigid former.

By using a silicone-free resilient polymer layer on a rigid former, the overall cost of the mould is reduced. As the rigidity of the mould is provided by the former, a wider range of resilient materials may be used in forming the mould. When a non-silicone containing material is used as the layer in contact with the moulded gasket, the mould lifetime is increased, as the problem of polyurethane absorption into the surface pores of the silicone is removed.

Preferably, the silicone-free resilient polymer material is polyurethane. More preferably, the polyurethane is formed from a prepolymer comprising the reaction product of isocyanate and polyols, and a chain extender. Preferably the rigid former is low density polyethylene. The surface of the first half mould may also comprise a releasable coating. Preferably, the releasable coating does not react with the layer of resilient material.

The mould may further comprise a second mould half, wherein the first and second mould halves are-complementary, and the second half mould also comprises a moulding surface for moulding a gasket onto a glazing. At least one of the first and second half moulds may be provided with cavities to receive components to be bonded to the surface of the glazing. Preferably, both the first and second half moulds comprise a layer of a resilient material supported on a rigid former.

The mould may comprise a rigid support for supporting a glazing within the glazing encapsulation mould. Preferably, the mould is for use with a polyurethane mix having a short gelling time and entering the mould under low or atmospheric pressure.

The present invention will now be described by way of example only, and with reference to the accompanying drawings, in which:

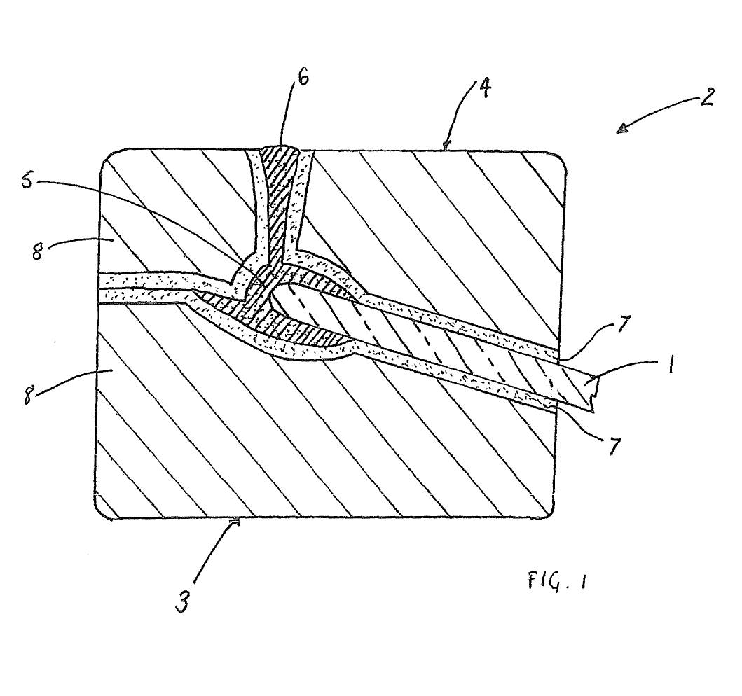

FIG. 1 is a schematic cross-section showing the two halves of a mould in accordance with a first embodiment of the present invention clamped around a glazing;

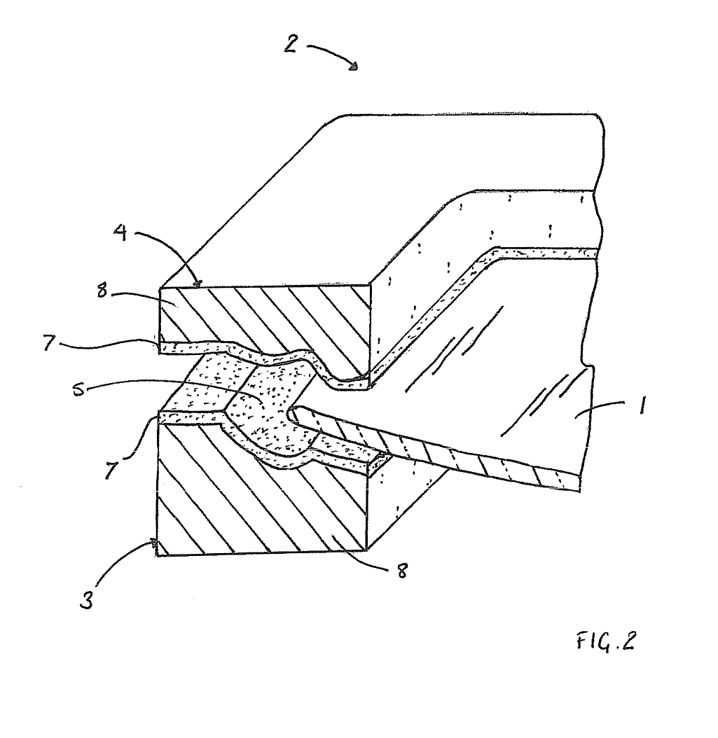

FIG. 2 is a schematic perspective view showing the two halves of the mould in accordance with the first embodiment clamped around a glazing;

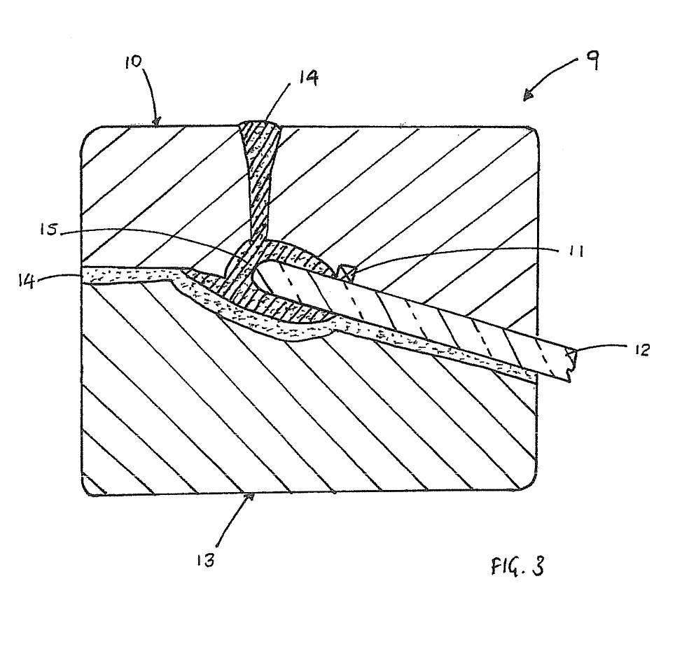

FIG. 3 is a schematic cross-section showing the two halves of a mould in accordance with a second embodiment of the present invention clamped around a glazing; and

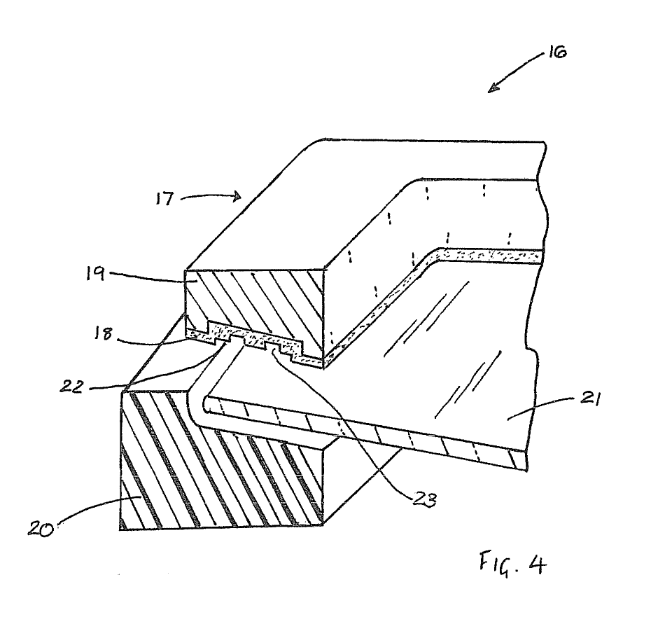

FIG. 4 is a schematic perspective view showing a mould in accordance with a third embodiment of the present invention.

FIG. 1 is a schematic cross-section showing the two halves of a mould in accordance with a first embodiment of the present invention, clamped around a glazing. In order to provide a gasket around the periphery of a glazing 1, the glazing 1 is placed into a mould 2. The mould 2 comprises two half moulds, each having a moulding surface: a first half mould 3, on which the glazing 1 rests; and a second half mould 4, which covers the glazing 1 and closes onto the first half mould 3. The two half moulds 3, 4 are self-sealing and fit together such that when the mould 2 is closed, a seal is formed between the two half moulds 3, 4 and the glazing 1. By using a self-sealing mould, polyurethane flashes around the edge of the gasket can be avoided. The moulding surfaces of the two half moulds 3, 4 are contoured such that when the mould 2 is closed around the glazing 1, a cavity 5 is formed. The cavity 5 has the same shape and position on the glazing 1 as the final form of the gasket. A casting hole 6 is provided in the second half mould 4, to allow polyurethane precursors to be injected into the mould 2 and the cavity 5. The mould is intended for use with a polyurethane mix having a short gelling time (time taken to reach a viscosity that will not cast freely at 25° C. of approximately 30 s) and entering the mould under low or atmospheric pressure (less than 3 kg/cm²).

Each half mould 3, 4 comprises a silicone-free resilient polymer layer 7 supported on a rigid former 8. The contours of the moulding surface are determined by the rigid former 8, and the silicone-free resilient polymer layer 7 provides flexibility to absorb the force placed on the glazing when the mould 2 is closed. In this context, resilient is taken to mean a material that is sufficiently flexible to absorb the stress produced on the glazing when the mould is closed or the glazing otherwise pressed against the surface of the mould, without causing cracking of the glazing itself. Rigid denotes a material that does not flex under the force of the closed mould or weight of the glazing. Preferably, the silicone-free resilient polymer layer is formed of polyurethane, which itself is formed from a prepolymer comprising the reaction product of isocyanate and polyols, and a chain extender. For example, a pure diisocyanate type MDI (diphenylmethane-diisocyanate) having 33.6% of NCO, is reacted with a polyether with OH numbers equal to 56. By using 55 g isocyanate and 45 g polyether, the prepolymer contains 16.5%±0.3 of free NCO. 100 g of the prepolymer is mixed with 138 g of a mixture comprising 127 g of polyols having a molecular weight of 2000, 11 g of butandiol, 1.0 g of a UV absorber, 0.8 g of an amino catalyst and 2.2 g of pigment to give an NCO index of approximately 1.05. Such a composition has a gelling time of approximately 90 seconds at 35° C. This gelling time is greatly reduced compared with the curing time for a silicone mould of 24 hours. Therefore, if a half mould needs to be replaced for any reason, such as damage to the silicone-free resilient polymer layer 7, and a preformed rigid former is used, a new mould half can be made and ready for placement into a production line in a matter of hours.

The rigid former may be formed from any suitable rigid material, and may be preformed or formed within a master as described below. The thickness of the former is dependent upon the rigidity of the material used to make it. Preferably, the rigid former is formed from one of low-density polyethylene, polyvinyl chloride, polyester, foamed polyurethane, polyester-fibreglass composites or wood.

Preferably, the mould is designed in a ring shape. This allows a gasket to be moulded at any point on the periphery of the glazing, and reduces the cost of the mould. FIG. 2 shows a perspective view of the mould 2, which is designed to surround the periphery of a glazing 1. The mould 1 comprises two half moulds 3, 4, which contact the periphery of the glazing 1, leaving the majority of the surface area of the glazing uncovered.

The half moulds 3, 4 may be manufactured by one of two different processes, depending on the nature of the rigid former. Firstly, if the rigid former is formed by the polymerisation and/or hardening of a plastics material, the precursors of the resilient material are cast onto a reproducible model, such that the material reticulates on the model, creating the desired mould surface. Once the plastic mould material has solidified, the plastics material forming the rigid former is cast onto the solidified silicone-free resilient polymer layer. Once the former has hardened, the model is removed.

Secondly, if the rigid former is pre-formed, with the moulding surface already defined, the precursor material for the silicone-free resilient polymer layer may be poured directly onto the former for polymerisation. The rigid former may be shaped by casting, moulding, machining or any other suitable method, depending on its material constitution.

In order to mould a gasket, the low-pressure injection moulding method described in EP 0 792 209 B1 may be used. A glazing 1 is placed onto the first mould half 3, and the second mould half 4 placed on top, closing the mould 2 and sealing the glazing 1 into the mould 2. The mould 2 is then filled with polyurethane precursors under a pressure of less than 3 kg/cm² or at atmospheric pressure in what is known as an open mould condition. The filling pressure is measured using a gauge at the point the precursors enter the mould. Preferably the filling composition comprises a prepolymer belonging to the family of reaction products between aromatic and/or aliphatic isocyanates modified so as to be in the liquid state between 25° C. and 35° C., and polyols (polyether and/or polyester and/or polycaprolactones). In order to obtain a polyurethane elastomer, such prepolymers are then reacted with an adequate amount of chain extender, chosen from aromatic compounds, aliphatic amines and/or short chain polyols having an NCO index in the range 1.00 to 1.10. The components are chosen to give a short gelling time (time taken to reach a viscosity that will not cast freely at 25° C.) of approximately 30 s at 25° C. Before filling, degassing is carried out. In addition, the first mould half 3 has an exit hole (not shown in the Figures) which is equal to or greater in size than the casting hole, so to encourage flow of the filling composition within the mould 2. The temperature within the mould is maintained by the exothermic polymerisation reaction between the components of the filling composition.

If desired, the moulding surfaces of the half moulds may have a releasing agent applied before the moulding of the gasket. Such releasing agents are used to aid in the removal of the glazing from the mould once the gasket has hardened, and also to help remove any excess polyurethane which may be left on the surface of the glazing after moulding. Suitable releasing agents include waxes dissolved in non-polar solvents; aqueous solutions of polyurethane resins; hydro-alcoholic solutions of polyurethane resin; polyurethane resin-solvent mixtures (preferably the polyurethane resin is aliphatic); aqueous solutions of acrylic resins; alkaline metal soaps and fluorocarbon resins.

As an alternative to the mould design shown in FIGS. 1 and 2, where both of the half moulds are formed of a layer of resilient material supported by a rigid former, a second embodiment of the present invention is shown in FIG. 3. In this situation, the mould 9 has had one of the half moulds replaced with a metal half mould 10. In FIG. 3, the second or upper half mould is replaced with a metal half mould. A rubber gasket 11 is included in the half mould 10 to ensure a good seal against the glazing 12. By using one half mould formed of a resilient material, any pressure on the glazing when the mould closes, which may damage or break the glazing, is absorbed. By using a metal half mould 10, the overall cost of the mould 9 is reduced, as only the first half mould 13 will need to be replaced if the silicone-free resilient polymer layer 14 becomes damaged. Again, the metal half mould 10 may be used in conjunction with releasing agents if desired. A casting hole 14 is provided in the second (metal) half mould 10, to allow polyurethane precursors to be injected into the mould 9. This enables the moulding of a gasket within a cavity 15 using polyurethane precursors, as described above.

In addition to moulding the gasket, other preformed parts can be placed within the mould in order to be bonded to a surface of the glazing by the polyurethane. For example, one of the half moulds 3, 4, 10 may have additional cavities for receiving locating pins, finishers, inserts, mirror bosses and the like, which are then contacted with the surface or edge of the glazing when the mould is closed.

FIG. 4 shows a schematic perspective view of a mould in accordance with a third embodiment of the present invention. In this embodiment, the mould 16 comprises a mould half 17, formed from a resilient material 18 on a rigid former 19, and a rigid support 20, which may be formed from metal, plastics material, wood or the like. The rigid support 20 supports the glazing within the glazing encapsulation mould, by supporting the weight of the glazing 21 and maintaining its position during moulding. The mould half 17 is effectively therefore a single mould, such that when it contacts a major surface of the glazing 21, indents 22 in the surface of the mould half 17 form a cavity 23 form moulding a gasket onto the glazing 21. The mould half 17 may be provided with a casting hole (not shown) to enable the mould 16 to be used in a RIM process. Alternatively, the mould half 17 may be used without a support, in an inverted position with the glazing 21 resting on the surface of the mould half 17. Such a mould is suitable for use with other casting and moulding techniques, such as that described in DE 41 03 047.

As an alternative or in addition to using a conventional releasing agent, which is subsequently washed off the glazing, the surface finish of the moulding and the lifetime of the mould may be improved with the use of a releasable coating. The releasable coating is one which does not react with the mould material, and hence remains chemically separate, acting as a barrier layer between the polyurethane formed in the mould during the injection moulding process and the silicone-free resilient polymer layer on the rigid former. Alternatively or additionally, the releasable coating is impermeable to the material used to mould the gasket. During the polymerisation process, the releasable coating bonds with the reacting polyurethane precursors, and is incorporated into the moulded gasket. The releasable coating forms the surface layer of the gasket, and therefore the properties of the releasable coating determine the surface finish and/or properties of the gasket. For example, the releasable layer may impart improved resistance to damage to the gasket by UV light; improved weather resistance; a textured, matte or gloss surface finish; abrasion resistance properties; or a surface colour. Suitable materials for such a layer include aliphatic polyurethane resins or acrylic resins.

The mould described above is suitable for use with a variety of automotive glazings such as windscreens, rooflights, backlights, sidelights, and any other glazing used in automotive vehicles. The glazing 1, 12, 21 may be a laminated glazing (comprising two plies of annealed or semi-toughened glass having an interlayer laminated in between) or may comprise a single ply glazing, of toughened or semi-toughened glass. Additionally, the glazing may be printed or comprise a coating.

1. An automotive glazing encapsulation mould comprising at least a first half mould, having a moulding surface for moulding a gasket onto a glazing, wherein the moulding surface comprises a layer of a silicone-free resilient polymer material supported on a rigid former.

2. The automotive glazing encapsulation mould of claim 1, wherein the silicone-free resilient polymer material is polyurethane.

3. The automotive glazing encapsulation mould of claim 2, wherein the polyurethane is formed from a prepolymer comprising the reaction product of isocyanate and polyols, and a chain extender.

4. The automotive glazing encapsulation mould of claim 1, wherein the rigid former is low density polyethylene.

5. The automotive glazing encapsulation mould of claim 1, further comprising a releasable coating on the moulding surface of the first half mould.

6. The automotive glazing encapsulation mould of claim 5, wherein the releasable coating does not react with the layer of resilient material.

7. The automotive glazing encapsulation mould of claim 1, further comprising a second mould half, wherein the first and second mould halves are complementary, and the second half mould also comprises a moulding surface for moulding a gasket onto a glazing.

8. The automotive glazing encapsulation mould of claim 7, wherein at least one of the first and second half moulds is provided with cavities to receive components to be bonded to the surface of the glazing.

9. The automotive glazing encapsulation mould of claim 7, wherein both the first and second half moulds comprise a layer of a resilient material supported on a rigid former.

10. The automotive glazing encapsulation mould of claim 1, further comprising a rigid support for supporting a glazing within the glazing encapsulation mould.

11. The automotive glazing encapsulation mould of claim 1, wherein the mould is for use with a polyurethane mix having a short gelling time and entering the mould under low or atmospheric pressure.
